(19) United States
(12) Patent Application Publication
(10) Pub. No.: US 2021/0169027 A1
(43) Pub. Date: Jun. 10, 2021

(54) GROW TOWERS

(71) Applicant: Eden Growth Systems, Inc., Houston, TX (US)

(72) Inventor: Jeffrey Lee Raymond, White Salmon, WA (US)

(21) Appl. No.: 17/180,374

(22) Filed: Feb. 19, 2021

Related U.S. Application Data
(63) Continuation-in-part of application No. 16/445,528, filed on Jun. 19, 2019.
(60) Provisional application No. 62/688,450, filed on Jun. 22, 2018.
(60) Provisional application No. 62/978,424, filed on Feb. 19, 2020.

(51) Int. Cl. A01G 31/06; A47B 37/00; A01K 63/04

(52) U.S. Cl. CPC A01G 31/06; A47B 37/00; A01G 2031/006; A01K 63/045; A01K 63/047; A01K 63/042

(57) ABSTRACT

This disclosure pertains to modular, moveable light weight structures, i.e., grow towers, including supporting tubing and pumps, used for a hybrid aeroponic and aquaponic growth method of plants and aquaponic growth of animals such as fish wherein the each of the plants and animals are balanced in quantity and produce nutrients that support the growth of the other, i.e., plants and animals. The disclosure also includes an array of sensors, software utilizing artificial intelligence and a CPU for monitoring, controlling and facilitating the growth. The structure and methods utilize and maintain a substantially equilibrium growing conditions requiring minimum intervention. The structure and method also utilizes monitoring of multiple growth variables with systems and CPU programing to adjust and maintain equilibrium conditions.

### RELATED APPLICATIONS

This disclosure claims priority to and incorporates by reference herein in their entirety provisional application Ser. No. 62/688,450 filed Jun. 22, 2018 entitled “Scalable, Bioregenerative Crop and Energy Production System for Terrestrial and Non-Terrestrial Use”, application Ser. No. 16/445,528 filed Jun. 19, 2019 entitled “Scalable, Bioregenerative Crop and Energy Production System for Terrestrial and Non-Terrestrial Use” and provisional application Ser. No. 62/978,424 filed Feb. 19, 2020 and entitled “Grow Towers”. This Application is a Continuation In Part of application Ser. No. 16/445,528.

### FIELD OF USE

This disclosure pertains to structures, including tanks, lighting, supporting tubing and pumps, used for a hybrid aeroponic and hydroponic growth method of plants and aquaponic growth of aquatic animals such as fish or shrimp wherein the each of the plants and animals are balanced in quantity and produce nutrients that support the growth of the other, i.e., plants and animals.

The disclosure teaches a series of self-sustaining units or “towers” that can be linked together to sustain varying populations of inhabitants.

### BACKGROUND OF DISCLOSURE

It has been a past theorized goal of achieving a self-supporting system operating in equilibrium to support both animal and plant growth. It has been part of this theorized goal to allow such an equilibrium system to support human life. A famous but unsuccessful attempt was the Biosphere 2 project of the 1990's. Attempts to build a comprehensive self-sustaining habit have been unsuccessful.

### SUMMARY OF DISCLOSURE

The system and method of the disclosure utilizes one or more tanks or other structures that can support animal life such as fish. The disclosure also utilizes containers or tanks through which water flows and provides nutrients to plant roots growing hydroponically. The combination of systems is referenced as aquaponics.

In one embodiment, the system may utilize hydroponics wherein the plant roots receive water and nutrients through a mist. In some embodiments, the moisture is delivered through misting particles of 50 microns or greater. This is termed hydroponics. The mist can be delivered in timed intervals. Correct nozzle pressure must be maintained to create the mist. In another embodiment, the moisture and nutrients are delivered through a “fog” or vapor consisting of particles less than or equal to 50 microns. This embodiment is termed aeroponics. In one embodiment, this aeroponic nutrient moisture vapor may be circulated beyond the plant root system to the stems and leaf buds. Aeroponics allows growth of plant species not suitable to hydroponics such a tubur plants, e.g., potatoes. Hydroponics and aeroponics utilize approximately 2-6 percent of the water utilized by traditional grow methods.

It will be appreciated that excess moisture and nutrients may be collected in the underlying tank for recycling as described below. For example, see FIG. 11.

The disclosure also includes one or more filters that enable the nutrient rich water from the aquaculture species to be micronized and sprayed directly on the roots of the growing plants. Pumps, piping, lighting, and automated controls are also included.

With reference to an aquaponic system, it will be appreciated that the plants utilize photosynthesis to transform CO₂ to O₂. Conversely the animals consume O₂ and exhale CO₂. An aquaponic system comprises tanks growing animals such as fish or scrimp. The system also comprises one or more tanks growing plants using a hydroponic water mist or aeroponic fog or vapor of water. Part of the disclosure is to maintain an equilibrium of between O₂ and CO₂ supply. It will be further appreciated that multiple other variables must be monitored and controlled by the system subject of the disclosure including but not limited to temperature, pH, pressure, water flow, CO₂ and O₂ levels, etc. Reference is made to Applicant's pending disclosure Ser. No. 16/445,528 filed Jun. 19, 2019 and which is incorporated herein in its entirety.

The grow towers subject of this disclosure may be modular and configured for each use. The grow towers have the advantage of being quickly reconfigured to grow a variety of plants such as potatoes, corn, hemp, etc. These are plant species not readily grown in traditional hydroponics.

Also, the towers may be portable and transportable (assembled and disassembled). The structures can be constructed of rigid lightweight material. Also, the structures can be coated with anti-bacterial agents or sealed surfaces for cleaning. The structures and components described herein are also to be food grade such as stainless steel, aluminum, molded plastic or silicon.

The structures can consist of a stand on to which vertical oriented sides can be installed. There can be variably positioned horizontally oriented shelve or rail structures that can support various sized tanks or shelving. In an embodiment, the top of the structure can support grow lighting or solar panels to facilitate plant growth.

The bottom section of the structure, in one embodiment, may contain motors, pumps, filters, flow controls and valves, sensors of various kinds and a control and/or display panels. The control component may include a CPU capable of operating software utilizing artificial intelligence.

### SUMMARY OF DRAWINGS

The accompanying drawings, which are incorporated in and constitute a part of the specification, illustrate preferred embodiments of the disclosure. These drawings, together with the general description of the disclosure given above and the detailed description of the preferred embodiments given below, serve to explain the principles of the disclosure.

The disclosure teaches stackable tanks that may be configured with vertically oriented sides to create grow towers. This novel arrangement allows efficient use of floor space by allowing multiple tanks or containers for plant or animal growth and habitat to be vertically oriented. The tanks can be placed to provide adequate air circulation and space for vertical growth for plants.

It will be appreciated that the drawings are examples only and are not intended to be to scale. Attachment fixtures are also only examples and other fixtures or configurations are included within the scope of this disclosure.

FIG. 1 illustrates a perspective view of one embodiment of the grow tower subject of this disclosure. The modular universal tower base (bottom component) may house pumps, motors, piping connections, valves, sensors or sensor controls, etc. Also illustrated are the vertical oriented sides supporting horizontal shelves or other components such as water containing containers or tanks for plant or animal growth, e.g., multi-modular reservoirs. The piping is not shown. Note one component (plant grow tank) comprises a horizontally oriented lid device containing numerous perforations through which plants can grow. Flexible grow cup and lid combinations may be placed in each perforation. It will be appreciated that the flexible grow cup and lid will allow expansion as the plant stalk and root system grow. Also shown is a modular universal grow deck, an integrated fan component (which may be inserted or attached to the vertical sides), moveable height adjustable trellis for plant support and a modular light deck, e.g., full spectrum LED light configuration.

FIG. 2 shows a perspective view of another embodiment of the disclosure have two grow decks and a control display. The tower base may contain motors, pumps, waste digester, sensors or sensor controls and control/display panel. Note in the embodiment illustrated, an equipment access door is illustrated.

FIG. 3 illustrates perspective view of a variation of an embodiment having a deep root capacity for growing plants such as potatoes or other tubular plants. It will be appreciated that the plant roots extend beneath the lid and grow cup combination and are fertilized by controlled micronized flow water containing nutrients. The pattern perforations/grow cups facilitate weed control and disbursement of herbicides and pest control materials with minimized contamination of the water below the lid. The lids also facilitate the maintenance of humidity for the roots receiving the mist. The top surface of the structure may support plant growth lights or solar panels. It will be appreciated that water flow control piping and other features subject of the disclosure are not illustrated.

FIG. 4 illustrates another embodiment of the disclosure with a grow tank positioned a distance beneath the grow lights. This will facilitate growth of relatively tall plants such as corn. The grow lights may be retracted or raised as the plant grows in height.

FIG. 5A illustrates a top view of the modular base which may be incorporated in different configuration of the disclosure. In an embodiment, the base can contain a digestor for conversion of waste (such as animal waste) to nutrients.

FIG. 5B illustrates a perspective view of the base. The base may include wheels for mobility of any tower configuration.

FIG. 6 illustrates a perspective view of a grow tank design of one embodiment of the invention. The top comprises a removable lid structure having perforations for inserting and holding expandable grow cups with cup lids shown. Beneath removable lid is a tank or grow volume. The tank is self draining and collects the excess mist or vapor sprayed on the plant roots. Waste plant stems or roots may be collected. Piping is not illustrated.

FIG. 7 illustrates a perspective view of on embodiment of the disclosure, i.e., a liquid storage tank from which nutrient laden and oxygenated water may be sprayed on the plant roots. It will be appreciated that in an embodiment of the disclosure, the tank may be positioned above the base containing one or more pumps. Also illustrated is a biofilter. It will also be appreciated that the tank is modular and can be positioned within the modular vertical frame of the tower. The tank has a sloped bottom for self draining.

FIG. 8A is a perspective view of the grow lights typically positioned at the top of the grow tower.

FIG. 8B is a perspective view of the full spectrum modular LED lighting with motorized height adjustment and trellis. The height of the light within the grow tower configuration may be controlled.

FIG. 8C illustrates an adjustable or variable height positioned trellis.

FIG. 9 is a perspective view of one assembled embodiment of the disclosure. Note the optional micro green work surface installed with the modular universal grow deck holding the grow cups and lids. This embodiment contains a modular base unit positioned beneath the modular reservoir. Note the position of the adjustable trellis and modular light deck.

FIG. 10 is a perspective view of the expandable grow cup used with the expandable lid fitting above the cup. The roots of the plant extend through the pliable or expandable perforations of the cup and the plant stalk and leaves extend through the perforations of the lid.

FIG. 11 is a side view of the interior of one embodiment of a grow tank illustrating the position of the mist or fog sprayers (emitters). Also illustrated is the sloped self draining tank bottom.

### DETAILED DESCRIPTION OF DISCLOSURE

This disclosure describes a grow tower that can be used in conjunction with a system for growing animal and plant food in an intended equilibrium system with minimum maintenance and addition of resources. In one embodiment, no intervention is required other that harvesting the food.

In an embodiment, the production of CO₂ by the living animal stock, e.g., fish, of the system matches the CO₂ demand of the growing plant food. Further, the O₂ demand of the animal stock is matched by the O₂ production achieved by photosynthesis of the plants.

Reference is made to Applicant's co-pending application Ser. No. 16/445,528 filed Jun. 19, 2019 entitled “Scalable, Bioregenerative Crop and Energy Production System for Terrestrial and Non-Terrestrial Use” and provisional application Ser. No. 62/978,424 filed Feb. 19, 2020 and entitled “Grow Towers”. Both applications are incorporated herein by reference in their entirety.

The drawings show four main configurations of the Applicant's modular grow tower system and their major modules. The four “Initial” configurations are:

Single deck tower

Double deck tower

Potato/Tuber tower (Note there is no known prior art allowing growth of these types of plants.)

Tall deck tower

The prior art is not known to disclose modular solutions (meaning what you buy is what you get, and it can't be changed). The Applicant's disclosure allows users to mix and match various “modules” together to create standard or even customer unique configurations depending upon need, space and intended use.

These configurations are made through the assembly of four key modules: base, reservoir, grow deck (grow tank), and light deck. The decks are supported upon modular vertically oriented sides that allow installation of the various decks at adjustable heights.

The vertical sides may be modular, i.e., may come in differing lengths that can be removably joined together to a desired length. The joining mechanism may be a male-female end combination. The joining mechanism can be a threaded combination or be “snap-on” utilizing detents. The vertical sides may have regular spaced holes for fitting other components such as horizontally side support/stabilizing rails or trellis. In one embodiment, the vertical sides contain holes at predetermined locations to accommodate specified spacing between the horizontal rails that may be used to position grow tanks as discussed below. In one embodiment, the rails are removably attached to the vertical sides with screws. Other attachment mechanisms can be used including spring fittings or key pins that have retractable male components insertable into the holes of the vertical sides.

In one embodiment, the top light structure or deck can be attached to a 12 inch, 36 inch or 72 inch vertical side component to accommodate differing sized plants.

In one embodiment, the grow tanks and reservoir tanks can utilize an extended top lip that sits or rests upon the horizontal rails. In other embodiments, the tank structures can be removably attached to the vertical side or attached to the horizontal rails.

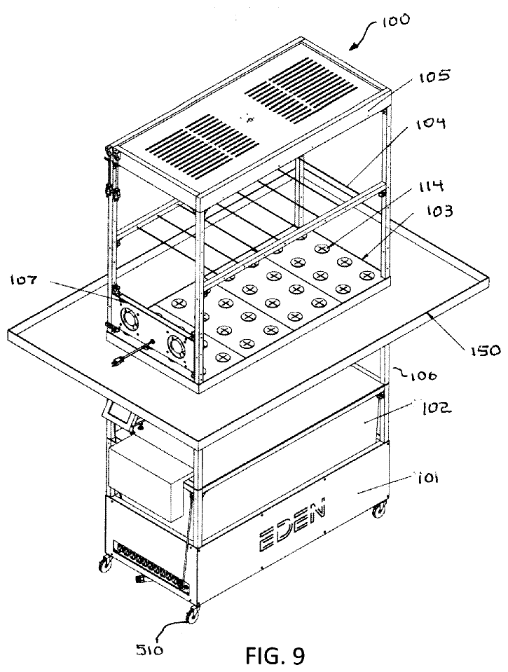

The disclosure includes a digester module (which is discussed below) and additional add on modules to allow for an increased surface area on each deck, such as the one illustrated in FIG. 9. The increased deck space will facilitate planting and harvesting. This add-on maintains the original grow space and created by the tower.

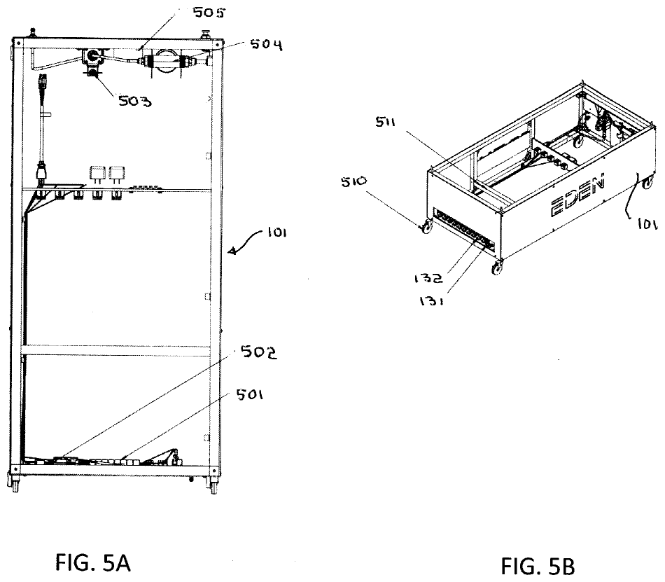

The base is shown on FIG. 5. The purpose of the base is to house the motors, computers, and electronics in such a way as to ensure food safety protocols are met and to minimize space required. The base is mobile to allow the easy movement of the entire system/tower. The major components of interest in the base are the integrated oxygen pump, the nutrient delivery pump, the aeroponic filter, the integrated computer for control and monitoring, the computer controlled Amer (aka relay/switches), the integrated power management panel, the fused power supply, and the sloped and concave nature of the bases' structure to allow for the maximization of used space (i.e. the reservoir sits down into the base to reduce total tower height) and to ensure proper drainage and ease of cleaning of all reservoirs used (this is a critical feature as it helps reduce labor). It is worth noting that the Applicant has reduced all system components down to the absolute minimum required/essential.

It will be appreciated that the reservoir tanks can have two functions. One function is to hold the nutrient containing water until called upon to increase water level in a grow tank of the system. This may require a supplemental pump as well as communication with water level sensors and controlling CPU. A second function is to provide a water volume for healthy aquaculture growth. It will be appreciated that the reservoir may be used as the source for positioning various water monitoring sensors such a temperature, CO₂ or O₂ content, pH, water chemical content such as nitrogen, etc.

Nutrients may, in one embodiment, be added in the reservoir. Once the reservoir is filled, either hydroponic nutrients or aquatic animals, e.g., fish, may be added. The reservoir bottom is sloped and at the deep end there may be a primary water drain which connect to the primary pump filter in the base unit. The water draining from the reservoir or grow tank may be connected also to a digester in the base unit. If the reservoir is stocked with aquatic animals, generated animal waste may be collected via the self-draining reservoir to the digester. In one embodiment, the digester may be used to recycle nutrients from human waste. Gas generation may be collected from the digestion process. From the digester, water flows to the primary pump filter. From the primary pump filter, the water circulation path continues to the primary pump where it is pump through tubing to the water sprayers or emitters within each grow tank. Excess water mist or spray collects at the sloped (self draining) end of the grow tank bottom where it can drain to the reservoir or directly to the primary pump filter.

In another embodiment, water collected from the grow tanks may be circulated through the reservoir before being circulated to the primary pump filter.

In addition to the primary pump filter, the primary drain also may connect to a “buddy breathing” or sharing supply line which can be connected to the primary pump of another grow tower, e.g., another grow tower that does not have a reservoir. This separate grow tower pump supplies water circulation, flow rate and pressure through the grow tanks. It is worth noting that one reservoir can support “buddy breathing: from 15 to 33 grow towers depending on what type of plants are being cultivated at the towers.

The “buddy breathing” configuration can also be used with additional grow towers that also contain reservoirs for growing of aquatic animals. The reservoirs may have their own water circulation system configured and controlled to optimize growth of aquatic animals without having to accommodate plant growth conditions. Such water circulation and control would not need to be shared with grow tanks also positioned on the towers.

The oxygen pump or air pump is used in all configurations that utilize a reservoir. The purpose of this device is to add oxygen to the nutrient supply (which can either be from fish or from hydroponic solution).

The nutrient delivery pump may be a high pressure pump (80 psi or greater) that is used to transport nutrient from the reservoir at the needed pressure, to the emitters in the grow decks, at such a rate as to “micronize” the particles to a specified diameter, e.g., 50 microns. In an embodiment, the flow rate of the water from the pump is approximately 1 gallon per minute.

The aeroponic filter is used to ensure that the solution doesn't contain particles larger than the specified diameter, so that the emitters don't get plugged.

The integrated computer with non-transitory memory, allows for the software and artificial intelligence control of all growing parameters which include but are not limited to: light cycle, light quantity, water cycle/amount, and air flow. In addition to controlling the system, it also allows for the automated monitoring of various system parameters including but not limited to CO₂, temperature, humidity, etc., via the connecting of various sensors. In one embodiment, the artificial intelligence can detect inadequate lighting from detected slow increase in plant stalk height over time. Machine learning can be utilized to improve memory of successful selection and control of variable resulting in a timely and productive harvest of plants or animals.

The computer controlled switch is used by the computer to automatically switch the power to various systems, listed above, on and off.

The integrated power management solution is one that allows for minimum power cable use. Traditional solutions would have users run multiple power cords to outlets creating a hazardous and unsightly solution. The Applicant's disclosure only requires one power supply (which is fused in case of water event or over voltage/amp) and then all cables come directly from the tower.

The universal grow deck can be used with aquaponics (fish waste as nutrient source) or hydroponic (liquid nutrient solution) modes and is able to grow small root vegetables and leafy greens. It has an integrated fan which is used for the pollination and air circulation for all plants. The fan is a very important part as indoor growing solutions that don't offer a fan, but attempt to grow large stature plants, will have minimal success as plants grow stronger when they are challenged by air flow. No air flow results in weaker plants. Weaker plant structure causes inability to achieve tall and mature plants. The lids on the deck are removable as to allow easy harvesting, planting, and maintenance/cleaning of the deck. The deck and all materials used on it, are food grade. The bottom of the tank, i.e., root grow volume, is sloped at 1-2 degrees as to ensure proper water drainage to minimize anerobic zones being developed in the tank volume which can lead to root health issues and ultimately crop failure. Inside the grow deck are high pressure, micronizing emitters and holders. These holders ensure the optimum distribution of the micronized, e.g., 50 micron diameter water droplets to the roots of the plants being grown.

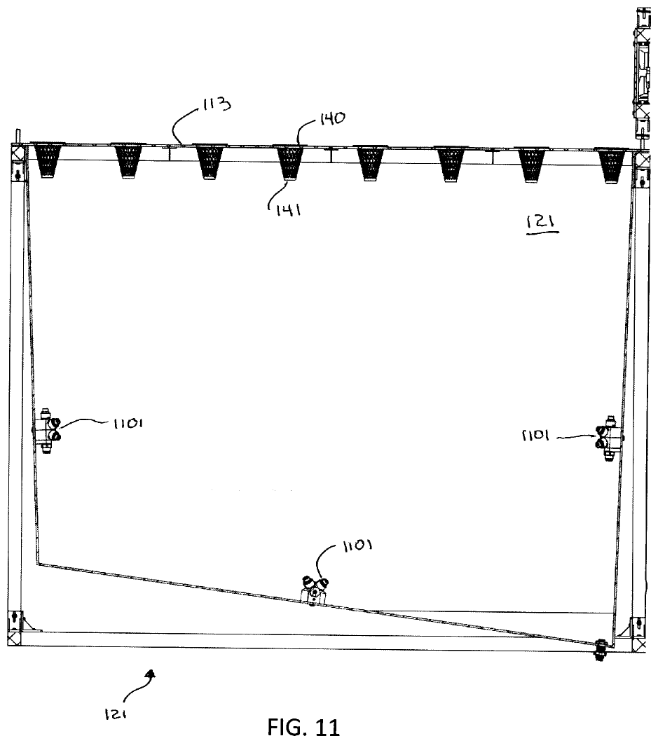

The Grow decks also utilize the novel design of expandable grow cups made of flexible food grade material enabling the growth of various root vegetables. These cups consists of two parts (FIG. 11), a lid and a cup. The cup is made of food grade flexible material (e.g. silicon) and is narrow enough to hold the grow media of the plant, but is flexible enough to expand with the plant (think of an onion growing and the silicon simple expands around it like a balloon being inflated). The lid is also made of flexible food grade material (e.g., silicon) so and is setup to perform three functions: 1. Minimize water loss through evaporation/spray, 2. Provide a dark environment for initial seed germination (i.e. with an Applicant's tower you don't have to start plants in another location and transplant, you can start them right in the tower itself), and 3. It creates some structure for larger stature plants to support themselves.

The reservoir is a bi-modal solution for nutrient containment. It's bi-modal in the sense that it can be used in both aquaponic (fish) and hydroponic (nutrient solution) modes. The tank is sized such that its large enough to allow for the healthy development of aquaculture species and is slopped such that all waste will naturally accumulate at the drainage end. It includes an evaporation control lid to further reduce use/loss rate of water. It also includes a integrated bio-filter which creates additional bio-reactive surface area for healthy bacterial growth which in turn leads to healthier plants.

The reservoir has another varient which allows it to be used as an anerobic digester. This digester module allows for the full recycling of organic matter into nutrient solution. The system may comprise an anaerobic digester which uses bacteria to decompose organic waste into liquid nutrients and bio-gas; a waste processing component to pre-process materials going into the digester a digestate pumping component, components to move digestate from the digester to the food production sub-system, a heating component which heats the digester and the air. It may be appreciated that power may also be furnished from methane gas (CH₄) produced from the operation of the waste digester described above. The digester module is an important component to enable self sustaining growth as it allows for the creation of nutrient without having to purchase nutrients, as long as the user recycles all organic waste into the system.

The final component is the light deck. The light deck as three variants, 12 inch, 36 inch, and 72 inch. These variants allow for the appropriate height spacing needed by various plant species to grow all types of crops, from small leafy greens (12 inch deck) to tomatoes (36 inch deck), and even industrial hemp or corn (72 inch deck). The 36 and 72 inch variants come with a moveable trellis structure to support the structural need of various plants. All variants utilize high efficiency, full-spectrum, LED Lighting. The 72 inch variant also includes an automated light height motor (controlled by the computer in the base), that adjusts the light height based on the type and growth stage of plant being grown.

All variety or configurations of the Applicant's disclosure include a touchscreen control panel for ease of operation and monitoring, as well as a wireless accessible software solution for full control and monitoring of the system. The software app allows for the sensing and control of various plant growth parameters, but most specifically, it includes: light duration and height/exposure, water duration/amount, and airflow control for pollination and plant health. Users add what plant species is planted where and the system takes over control of watering, light, and air flow. This further reduces human labor to the point of simply monitoring the system or responding to system requested actions such as filter cleaning.

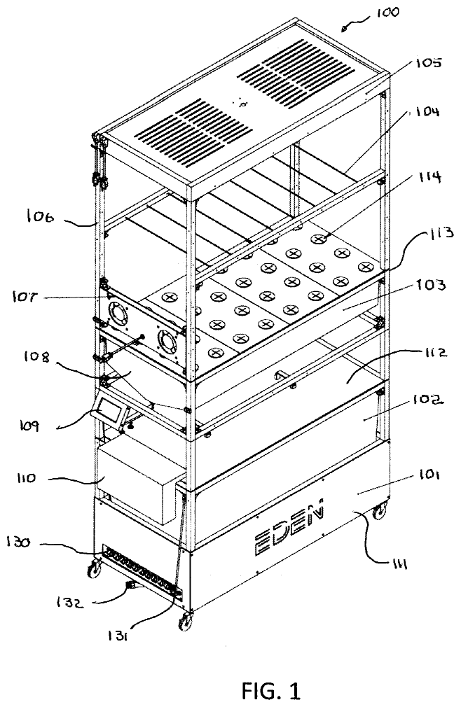

Referencing FIG. 1, the grow tower 100 comprises several basis components, e.g., the tower base 101, modular reservoir 102, modular grow deck 103, moveable trellis 104 and a modular light deck 105. Also the decks or components are adjustably positioned on vertically oriented and modular sides 106. It most configurations, the grow deck 103 includes an integrated fan component 107. The grow deck includes a cover lid 113 containing ordered perforations that may hold flexible grow cup/lid combinations 114. The grow deck also incorporates a sloped self draining tank 108. Also illustrated is a CPU display screen and integrated bio-filter 110. The tower base 101 may include an equipment access door 111. The reservoir 102 may include a reservoir cover 112. The grow tower also provides support for installation of circulating water piping among the above components.

The grow tower structure is adaptable to contain and support various sensors and sensor display devices to facilitate the balanced growth between animal, e.g., fish, and plant food. Such sensors may include oxygen concentration and carbon dioxide concentration sensors that measure the concentration at one or more locations of the circulation system. The pH and temperature of the water may also be monitored at one of more locations.

The system and method of this disclosure may be used in conjunction with a Automated Monitoring and Control System as disclosed in pending U.S. patent application Ser. No. 16/445,528 filed Jun. 19, 2019 and entitled “Scalable, Bioregenerative Crop and Energy Production System for Terrestrial and Non-terrestrial Use” which is incorporated herein by reference in its entirety. The Automated Monitoring and Control System may comprise multiple subsystems and components including but not limited to aquaculture feed production system, aquaculture breeding system, aquaponic pumping system, aquaculture waste management system, germination and pollination systems, fresh water supply system, temperature control system, humidity control system, water flow control systems, and light monitoring systems. Additional systems include an anerobic waste digester using bacteria to decompose organic waste and associated waste processing system, digestate pumping system, etc. Also a pest management system, air circulation system, and energy management and energy demand and supply systems.

Sensors may monitor and control selected substances such as nitrogen, phosphorus, potassium, calcium, sulfur, iron, boron, chloride, sodium, etc.

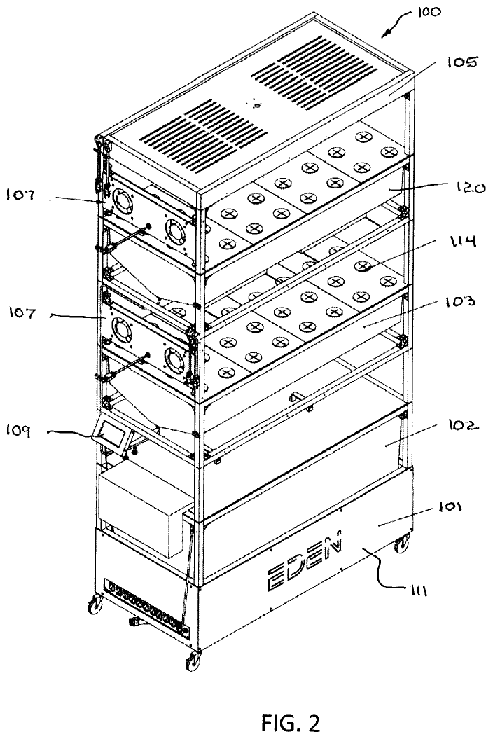

Referencing FIG. 2, a grow tower 100 is illustrated comprising two modular grow tanks 103, 120. Each grow tank incorporates an integrated fan 107.

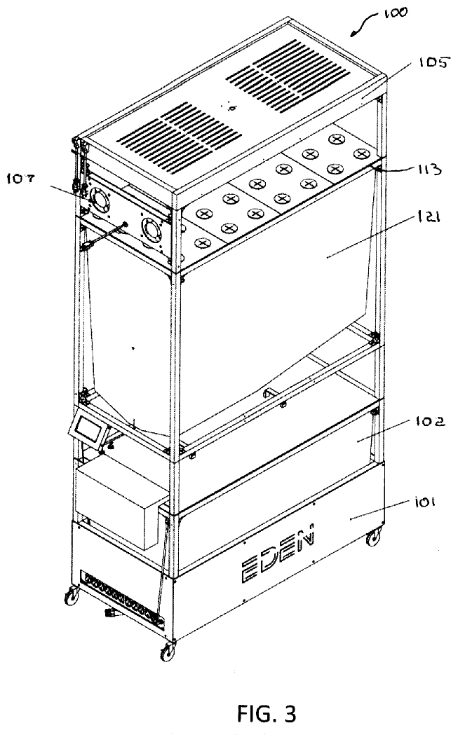

FIG. 3 illustrates a deep tank comprising a modular/tubular grow deck 121. It will be appreciated that the depth of the tanks is to accommodate the growth of an extensive root system contain tubular vegetables, e.g., potatoes. Again an integrated fan component 107 is disclosed.

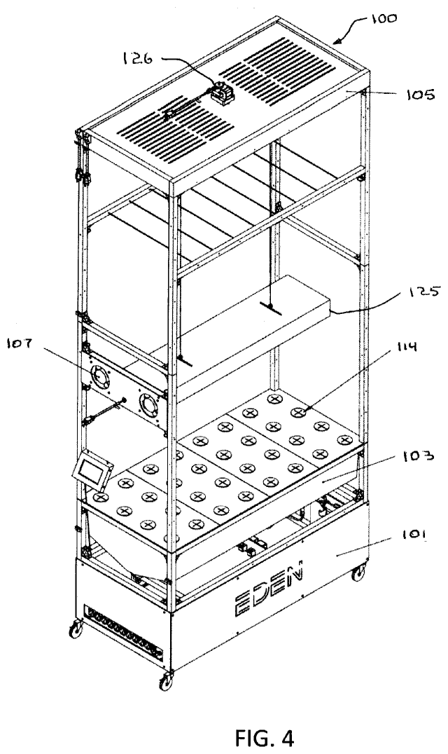

FIG. 4 illustrates a grow tower configured for the growth of tall plants such as corn or industrial hemp. The grow deck 103 is position above the tower base 101. An ordered configuration of flexible grow cup and lid combinations 114 are also illustrated. It will be appreciated that the cup and lid combinations occupy perforations (not shown) in the grow deck lid. Also the full spectrum modular lights are suspended from the light deck. The suspension elements convey power from the light deck as well as comprise retractable support components that are controlled by a motor 126 positioned with the light deck 105. Also illustrated is a height adjustable and removeable trellis 104.

In one embodiment, the power and other components of the tower are located in a base component 101. FIG. 5A illustrates a top view of the base component revealing various subcomponents such as a computer controlled timer 501, an integrated computer controller (CPU) 502. It will be appreciated that the CPU operates software having artificial intelligence capability to monitor and control multiple functions, thereby minimizing user involvement. Also illustrated is a nutrient delivery pump 503, integrated oxygenation pump 505 and an aeroponic filter 504.

FIG. 5B illustrates a perspective view of the grow tower base 101, illustrating wheels 510 for mobility of the tower, integrated power management 132 and a fused power supply input 131. These components may be accessed by a removable panel or access door 111. The equipment, in another embodiment may be accessed from the top. The grow tower base (modular) can also hold sensors and sensor controls as well as one or more display panels.

One novel feature of the disclosure is the scalable unitized configuration of components of the system. The height of the towers can be adjusted and multiple plant and/or animal growing containers can be placed on top of the other. Multiple tower units 100 can be placed along side each other. The configuration of individual or multiple towers can be adjusted to enhance system efficiency or as needs change. In an embodiment, the tower structure can incorporate wheels to facilitate repositioning the units.

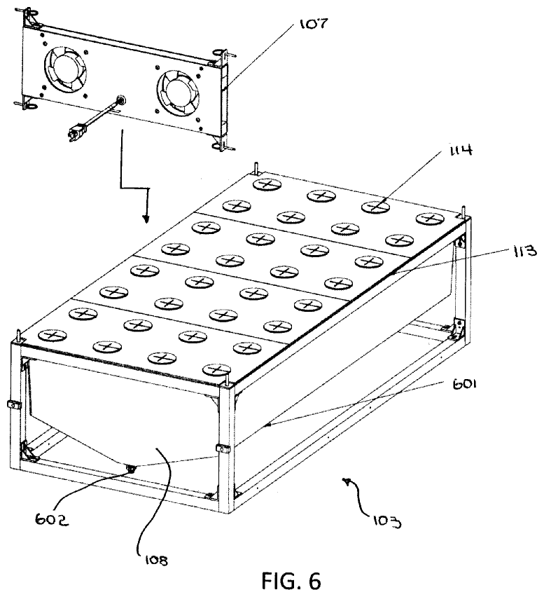

Referencing FIG. 6, as part of the adjustable configuration of each tower, the modular grow deck 103 is illustrated. It will be appreciated that the grow deck is held in a desired position by attachment mechanism in communication with the vertically oriented tower sides. The tower sides (vertical components) may be composed of sections of differing lengths, depending upon the requirements of the tower. Each vertical support section can comprise a top end that is a female fitting and a complementary second end comprising a male fitting. Therefore multiple vertical support sections can fit together without other mechanical attachments. Other configurations are possible including but not limited to mutually threaded rod ends or “snap together” fitting, such as employing detents.

The stability of the vertical tower sections can be enhanced by horizontal supports. These horizontal supports can be integrated into the various tanks.

In the illustrated embodiment, the modular grow deck includes a removable lid 113 contain order perforations (not shown), wherein each perforation or hole holds a combination of a flexible grow cup and lid 114. It is within these grow cups that the plant germinates. Transplanting of plants is not required by the Applicant's disclosure. Under the removeable lid 113 is the tank 108 comprising a plant root grow volume 601. The tank is sloped to allow self draining. There is also a drain mechanism 601. It will be appreciated that the drain mechanism can be connected to a piping and water circulation system (not shown). Within the grow tank 108 are positioned one or more sprayers or emitters that are sized to emit nutrient ladened water mist or vapor. This nutrient laden water interacts with and feeds the plant root system, thereby sustaining the plant. Oxygen generated by the plants is conveyed to the water which collects at the bottom of the self draining tank (and may be pumped to aquatic animals of a aquaponic system). Also illustrated in FIG. 6 is an integrated fan system 107.

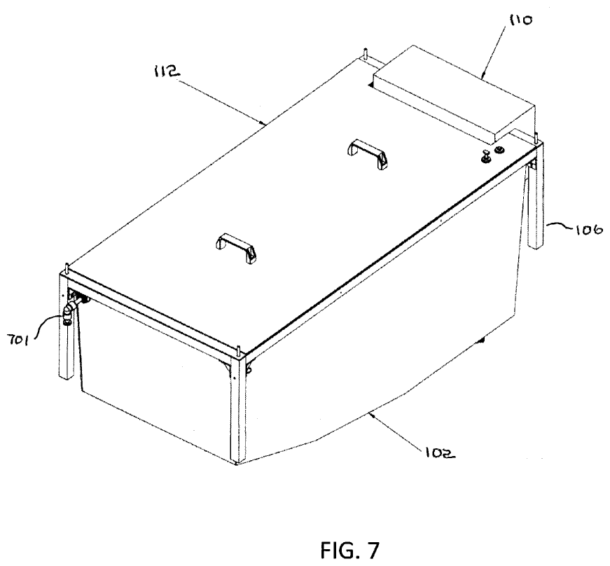

FIG. 7 illustrates the modular reservoir tank 102 of the disclosure. Also illustrated is a reservoir water inlet 701 which may be connected to the water distribution system of the grow tower. Also shown is the removable evaporation control lid 112 and integrated bio-filter 110.

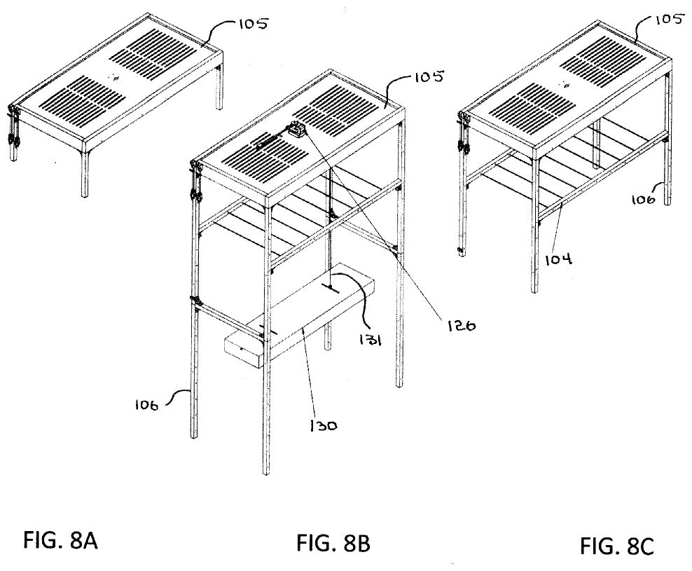

FIG. 8A illustrates the light deck module mounted on vertical supports. FIG. 8B illustrates the configuration wherein full spectrum LED lighting module is suspended and power by retractable power cords 131 controlled by the automated light height control motor 126 position on top of the light deck 105. Also illustrated are the vertically oriented side supports 106 of the tower. FIG. 8C illustrates the adjustable trellis deck 104 in conjunction with the side supports 106 and light deck 105.

FIG. 9 illustrates an optional deck “add on” 150 that can be positioned on the vertically oriented supports 106. This deck add on 150 provides an additional work surface for the user.

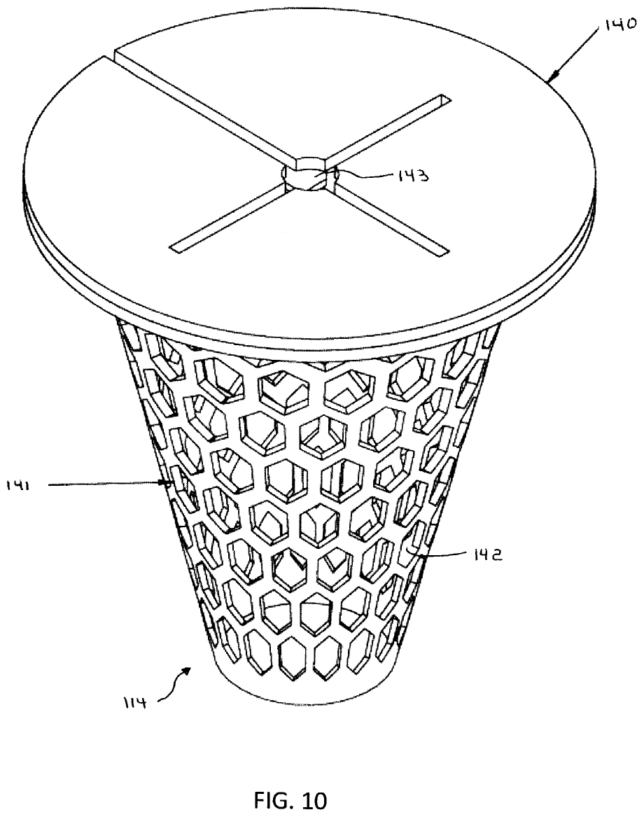

FIG. 10 provides a detailed perspective illustration of the grow cup 141 and grow lid 140 combination. Illustrated are the perforations 142 of the grow cup and perforations 143 of the grow lid. It will be appreciated that the cup and lid comprise flexible material that can expand with growth of the plant root system (through the perforations 142 of the cup) and plant stalk and leaves (through the perforation 143 of the lid).

FIG. 11 illustrates a side or cross sectional view of the expanded tank 121 discussed in conjunction with FIG. 3 above. Illustrated is one embodiment of a configuration of emitters 1101 to moisturize the plant roots suspended through perforations of the grow cups 141. The orientation of the removeable lid 113, grow cups 141 and lids 140 is illustrated. Again the tank is passively self-draining. Excess mist or vapor 1105 condenses and collects at the recessed end of the tank proximate to the drain mechanism 601. Again this drain mechanism may be in communication via tubing or pipes (not shown) with a pump located in the modular base. (See FIG. 5A).

Note the vertical orientation of the grow tower allows for gravity draining of water, thereby reducing the energy capacity of the pump system.

The towers can contain energy generators powered from methane gas produced as part of the digestion of waste to nutrients. The units may also incorporate solar power panels. In an embodiment, each unit may be energy independent.

As discussed, the tanks can be self-draining. This can be passive, i.e., the tank bottoms are sloped to a “low point”. See FIG. 11. This low point can be positioned with a drain. The drain can be connected to piping (not shown) that descends to a components, e.g., valves or pumps, positioned in the modular tower base. Note that an input port (not shown) may be positioned proximate to the top portion 603 of the tank opposite the “low point” 601.

Each tank can also have an overflow drain incorporated into or separate from the piping utilized with the self-draining port.

Each tank, whether used to support animal or plant growth, will also have an inlet port. This inlet port may be located at the end of the tank opposite the low point suitable for a drain port, thereby facilitating circulation of water through the length of the tank. The inlet port may be controlled by a valve (not shown). The valve can be controlled by the software operated by the CPU.

Novel features of the disclosure also includes an embodiment comprising lids 113 that can support plants. The plant roots may be suspended in the nutrient contain water circulating through the tank. The lid may hold one or more plants. The plant location relative to other plants contained within the tank can be controlled by openings of perforations in the top of the lid. See FIG. 8. This controlled positioning can facilitate control or elimination of unwanted plant growth. It can also facilitate that dispersal of pest control agents onto the plants with minimal loss or dispersal into the circulating water. It will be appreciated that the pest control agents may be detrimental to the animals/fish. This controlled dispersal will avoid a requirement of water filtration.

A further feature of the controlled locations of plant growth is that the system can be adopted to robotic applications for maintenance and harvesting.

It will be appreciated that towers 100 can be configured differently as requirements change. Also towers can be transported.

The tower components, e.g., tanks, piping, nozzles, vertical and horizontal supports can be constructed of lightweight material. Fiber reinforced plastics or similar are an option. These materials can be coated with bacteria growth retardant. In one embodiment, the material is stainless steel for cleaning and bacteria control.

The frame works can be installed with wheels. The support structures are shown with square cross-sectional components. Other shapes may be used including round or tubular.

It will be appreciated that there are numerous advantageous provided by the Applicant's disclosure, i.e., the ability to easily grow fresh food with minimal effort and with minimal space requirements. The Applicant's disclosure can provide adequate food supply for one person utilizing the approximate floor space of a queen size bed or 50 sq. feet. The disclosure allows the grow area to be scaled to allow food self sufficiency.

Other advantageous include having a ready supply of fresh food, thereby minimizing dependence upon other food sources, e.g., grocery stores. Food can be harvested year round and continuously regardless of location and weather. This also minimize storage requirements, time and costs.

Also the software, computer control and sensor array minimize user skill and knowledge required for growing a variety of plants and animal species. Few if any specialized tools are required. Use of pesticides and herbicides is minimized. Use of genetically modified food is not required.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims

What I claim is:

1. A system positioned in a modular tower structure with vertical orientation containing a plurality of horizontally oriented components capable of sustaining both plant and animal life comprising:
a. a first component comprising a system of pumps, monitoring and control sub-components positioned in a tower unit wherein the tower unit has a substantially vertical orientation and the first component can circulate water through a substantially closed spray and collection system;
b. a second component comprising a water reservoir also positioned in the tower unit and in water communication with the first component;
c. a third component comprising at least one water sprayer positioned in a tank subcomponent wherein the sprayer can be directed to plant roots extending down through flexible cups positioned above the tank; and
d. a fourth component comprising at least one light wherein the component is positioned in the tower unit and above the third component.

2. The system of claim 1 further wherein excess water emitted from the sprayer within the third component is collected within the tank and drains from the tank through a tube to the reservoir of the second component.

3. The system of claim 1 wherein water within the reservoir of the second component is pumped by a pump of the first component through a tube to the sprayer located within the third component.

4. The system of claim 1 further comprising at least one sensor capable of determining at least one property of water level, O₂ concentration in water, CO₂ concentration in water, nitrogen concentration in water, water pH, water temperature, or rate of water circulation and the sensor is in communication with a control subcomponent.

5. The system of claim 4 wherein the control subcomponent is positioned in the first component.

6. The system of claim 1 further comprising a fan for blowing air in a substantially horizontal direction above a top surface of the third component.

7. The system of claim 1 further comprising a digestor.

8. The system of claim 1 further comprising an oxygen or air pump for aerating the circulating water.

9. The system of claim 1 further comprising a component for sustaining aquatic animal life wherein the component is in water communication with the second and third component.

10. A plant or aquatic animal growing structure comprising:
a) a vertical rack structure capable of positioning a least a reservoir tank and a grow tank;
b) a base unit positioned on the vertical rack structure containing one or more pumps and electrical control components;
c) the grow tank containing at least one internal sprayer capable of spraying water on plant roots protruding down into the grow tank from a top surface of the grow tank; and
d) a tube system connecting the pump, reservoir tank, and grow tank for circulating water.

11. The growing structure of claim 10 further comprising an aquatic animal tank positioned on the vertical rack structure and in water circulating communication with the tube system connecting the pump, reservoir tank and grow tank.

12. The growing structure of claim 10 comprising one or more sensors for determining tank water level, water flow rate, water pH, O₂ concentration in water, CO₂ concentration in water, or water temperature.

13. The growing structure of claim 12 further comprising the sensor in communication with a CPU operating software for the control, at predetermined rates or ranges, of subcomponents such as water level valves, water circulating pump operation, aerating pump operation, water temperature control mechanism or pH control mechanism.

14. The growing structure of claim 10 wherein at least one grow tank or reservoir tank is self draining with a bottom surface having a slope of approximately 1 to 2 degrees of horizontal and an water outlet proximate to the lowest point of the bottom surface.

15. The growing structure of claim 11 further comprising a waste digester within the tube system for circulating water and the waste digester is structured to facilitate the transformation of waste into nutrients.

16. The growing structure of claim 11 wherein the water concentration of O₂ and CO₂ is maintained substantially in equilibrium.

17. The growing structure of claim 16 wherein the equilibrium is maintained by a controlled quantity of aquatic animals within the aquatic animal tank and quantity of plants wherein the roots of the plants are protruding down into the grow tank from a top surface of the grow tank.

18. The growing structure of claim 15 wherein aquatic animal tank is self draining with a bottom surface having a slope of approximately 1 to 2 degrees of horizontal and a water circulation outlet proximate to the lowest point of the bottom surface.

19. A plant or aquatic animal growing structure comprising:
a) a vertical rack structure capable of holding a least one grow tank;
b) a base unit positioned on the vertical rack structure containing one or more pumps, anerobic digester and electrical control components;
c) the grow tank containing at least on internal sprayer capable of spaying water having water droplets of 50 micron diameter or less on plant roots protruding down into the grow tank from a top surface of the grow tank; and
d) a tube system connecting the pump, anerobic digester, and grow tank for circulating water.

20. The plant or aquatic animal growing structure of claim 19 further comprising an aquatic animal tank in water circulation of the pump, anerobic digester, and grow tank.
